(19) United States
(12) Patent Application Publication
(10) Pub. No.: US 2009/0228337 A1
(43) Pub. Date: Sep. 10, 2009

(54) METHOD FOR EVALUATING COMPLIANCE

(76) Inventors: Gary Geiger Swindon, Herndon, VA (US); George Bradford Collins, South Riding, VA (US)

Correspondence Address: HOLLAND & KNIGHT LLP, 10 ST. JAMES AVENUE, BOSTON, MA, 02116-3889, US

(21) Appl. No.: 12/397,715

(22) Filed: Mar. 4, 2009

Related U.S. Application Data
(60) Provisional application No. 61/033,599, filed on Mar. 4, 2008.

(51) Int. Cl. G06Q 10/00

(52) U.S. Cl. 705/10

(57) ABSTRACT

A method and computer program product for transmitting a compliance questionnaire to one or more intended recipients. The one or more intended recipients is able to identify one or more delegated recipients of the compliance questionnaire. The compliance questionnaire is transmitted to the one or more delegated recipients.

### RELATED APPLICATION

This application claims the benefit of U.S. Provisional Patent Application No. 61/033,599, entitled “Compliance Survey Toolset”, filed 4 Mar. 2008, the entire disclosure of which is incorporated herein by reference.

### TECHNICAL FIELD

This disclosure relates to compliance evaluation and, more particularly, to an enhanced method of evaluating the compliance status of an entity.

### BACKGROUND

Entities such as banking institutions, hospitals, insurance companies, credit unions, and more have a responsibility to maintain policies and procedures that ensure their compliance with applicable standards. Compliance evaluation provides information regarding the compliance status of an entity relative to a defined standard. One tool utilized by entities to gauge their compliance status is a survey/questionnaire that may be distributed to recipients who presumably have knowledge of the policies and procedures implemented by the entity.

While surveys may be very useful tools when distributed to recipients with relevant knowledge, their usefulness may be diminished or wholly nonexistent when distributed to recipients with limited or no knowledge of the relevant policies and procedures of an entity.

### SUMMARY OF DISCLOSURE

In a first implementation, a method includes transmitting a compliance questionnaire to one or more intended recipients. The one or more intended recipients are able to identify one or more delegated recipients of the compliance questionnaire. The compliance questionnaire is transmitted to the one or more delegated recipients.

One or more of the following features may be included. It may be determined if the one or more intended recipients is qualified to answer the compliance questionnaire. Determining if the one or more intended recipients is qualified to answer the compliance questionnaire may include transmitting a qualifying questionnaire to the one or more intended recipients. At least one response provided by the one or more intended recipients in response to the qualifying questionnaire may be analyzed to determine if the one or more intended recipients is qualified to answer the compliance questionnaire.

It may be determined if the one or more delegated recipients is qualified to answer the compliance questionnaire. Determining if the one or more delegated recipients is qualified to answer the compliance questionnaire may include transmitting a qualifying questionnaire to the one or more delegated recipients. At least one response provided by the one or more delegated recipients in response to the qualifying questionnaire may be analyzed to determine if the one or more delegated recipients is qualified to answer the compliance questionnaire.

The compliance questionnaire may be generated based, at least in part, upon a compliance standard. The compliance standard may be selected from the group consisting of: adopted standards, entity standards, and governance models. A compliance report may be generated based, at least in part, upon one or more responses to the compliance questionnaire. The one or more responses to the compliance questionnaire may be filtered in accordance with filtering criteria defined, at least in part, by one or more of a questionnaire initiator, the one or more intended recipients, and the one or more delegated recipients. A statistical analysis of the one or more responses to the compliance questionnaire may be provided. Providing statistical analysis of the one or more responses to the compliance questionnaire may include enabling a questionnaire initiator to define one or more thresholds for the statistical analysis. The one or more thresholds may represent, at least in part, an interpretation of risk by the questionnaire initiator.

In another implementation, a computer program product resides on a computer readable medium having a plurality of instructions stored on it. When executed by a processor, the instructions cause the processor to perform operations including transmitting a compliance questionnaire to one or more intended recipients. The one or more intended recipients are able to identify one or more delegated recipients of the compliance questionnaire. The compliance questionnaire is transmitted to the one or more delegated recipients.

One or more of the following features may be included. It may be determined if the one or more intended recipients is qualified to answer the compliance questionnaire. Determining if the one or more intended recipients is qualified to answer the compliance questionnaire may include transmitting a qualifying questionnaire to the one or more intended recipients. At least one response provided by the one or more intended recipients in response to the qualifying questionnaire may be analyzed to determine if the one or more intended recipients is qualified to answer the compliance questionnaire.

It may be determined if the one or more delegated recipients are qualified to answer the compliance questionnaire. Determining if the one or more delegated recipients is qualified to answer the compliance questionnaire may include transmitting a qualifying questionnaire to the one or more delegated recipients. At least one response provided by the one or more delegated recipients in response to the qualifying questionnaire may be analyzed to determine if the one or more delegated recipients are qualified to answer the compliance questionnaire.

The compliance questionnaire may be generated based, at least in part, upon a compliance standard. The compliance standard may be selected from the group consisting of: adopted standards, entity standards, and governance models. A compliance report may be generated based, at least in part, upon one or more responses to the compliance questionnaire. The one or more responses to the compliance questionnaire may be filtered in accordance with filtering criteria defined, at least in part, by one or more of a questionnaire initiator, the one or more intended recipients, and the one or more delegated recipients. A statistical analysis of the one or more responses to the compliance questionnaire may be provided. Providing the statistical analysis of the one or more responses to the compliance questionnaire may include enabling a questionnaire initiator to define one or more thresholds for the statistical analysis. The one or more thresholds may represent, at least in part, an interpretation of risk by the questionnaire initiator.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a compliance evaluation system and a compliance evaluation application coupled to a distributed computing network;

FIG. 2 is a flowchart of a process executed by the compliance evaluation application of FIG. 1;

FIG. 3 is a diagrammatic view of a user interface rendered, at least in part, by the compliance evaluation application of FIG. 1;

FIG. 4 is a diagrammatic view of a user interface rendered, at least in part, by the compliance evaluation application of FIG. 1;

FIG. 5 is a diagrammatic view of a user interface rendered, at least in part, by the compliance evaluation application of FIG. 1; and

FIG. 6 is a diagrammatic view of a user interface rendered, at least in part, by the compliance evaluation application of FIG. 1.

Like reference symbols in the various drawings indicate like elements.

### DETAILED DESCRIPTION OF EXEMPLARY EMBODIMENTS

### System Overview:

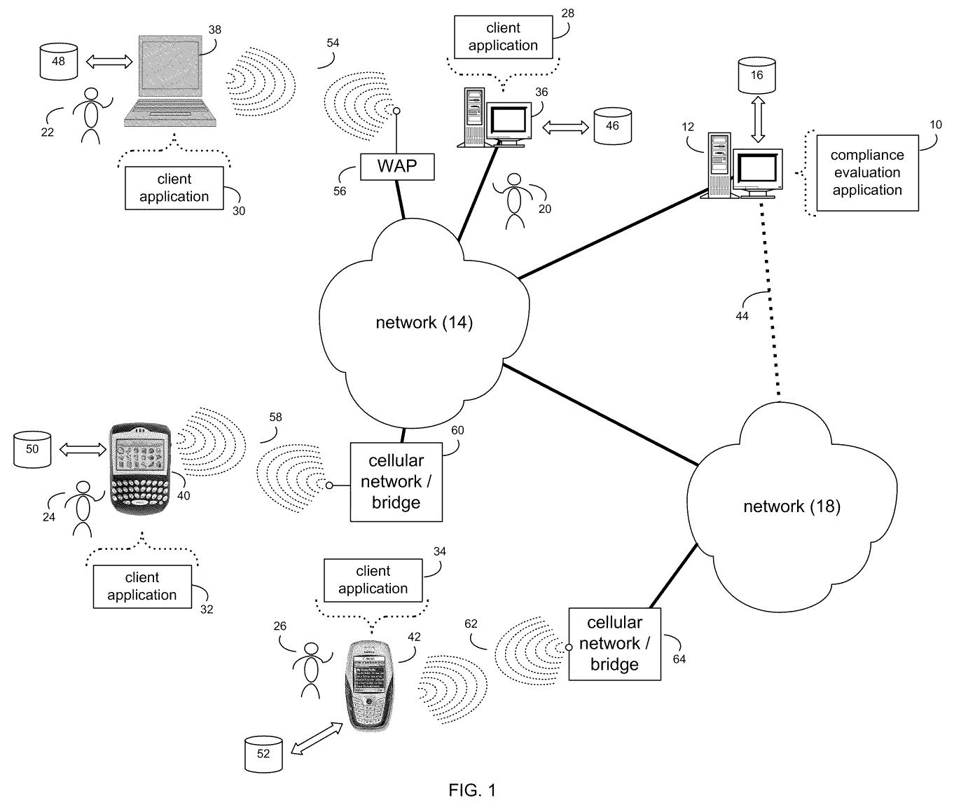

Referring to FIG. 1, there is shown compliance evaluation application 10 that may be a server application, which may reside on and may be executed by computer 12 (e.g., which may be a server computer). Computer 12 may be connected to network 14 (e.g., the Internet or a local area network). Examples of computer 12 may include, but are not limited to: a personal computer, a server computer, a series of server computers, a mini computer, a laptop computer, and a mainframe computer. Computer 12 may be a web server (or a series of servers) running a network operating system, examples of which may include, but are not limited to: Microsoft Windows Server™; Novell Netware™; or Redhat Linux™, for example. Additionally/alternatively, the compliance evaluation application may reside on and be executed, in whole or in part, by a client electronic device, such as a personal computer, notebook computer, personal digital assistant, data-enabled cellular device, or the like.

As will be discussed below in greater detail, compliance evaluation application 10 may transmit a compliance questionnaire to one or more intended recipients. Compliance evaluation application 10 may also enable the one or more intended recipients to identify one or more delegated recipients of the compliance questionnaire. Additionally, compliance evaluation application 10 may transmit the compliance questionnaire to the one or more delegated recipients.

The instruction sets and subroutines of compliance evaluation application 10, which may be stored on storage device 16 coupled to computer 12, may be executed by one or more processors (not shown) and one or more memory architectures (not shown) incorporated into computer 12. Storage device 16 may include but is not limited to: a hard disk drive; a tape drive; an optical drive; a solid state drive (SSD); a RAID array; a random access memory (RAM); and a read-only memory (ROM).

Computer 12 may execute a web server application, examples of which may include but are not limited to: Microsoft IIS™, Novell Webserver™, or Apache Webserver™, that allows for HTTP (i.e., HyperText Transfer Protocol) and/or HTTPS (HyperText Transfer Protocol Secure) access to computer 12 via network 14. Network 14 may be connected to one or more secondary networks (e.g., network 18), examples of which may include but are not limited to: a local area network; a wide area network; or an intranet, for example.

A user (e.g., users 20, 22, 24, 26) may access compliance evaluation application 10 via a client application (e.g., client applications 28, 30, 32, 34). The client application (e.g., client application 28, 30, 32, 34) may include, for example, a web browser (examples of which may include but are not limited to: Microsoft Internet Explorer™ available from Microsoft Inc, of Redmond, Wash.; Mozilla Firefox™ available from Mozilla Corporation, of Mountain View, Calif.; and Apple Safari™ available from Apple Inc., of Cupertino, Calif.), a proprietary/specialized client application suitable for interacting with compliance evaluation application 10, or other suitable client application.

A user (e.g., user 20, 22, 24, 26) may access compliance evaluation application 10 directly through the device on which the client application (e.g., client application 28, 30, 32, 34) is executed, namely client electronic device 36, 38, 40, 42, for example. The user (e.g., users 20, 22, 24, 26) may access compliance evaluation application 10 directly through network 14 and/or through secondary network 18. Further, computer 12 (e.g., the computer that executes compliance evaluation application 10) may be connected to network 14 through secondary network 18, as illustrated with phantom link line 44.

The instruction sets and subroutines of the client application (e.g., client applications 28, 30, 32, 34), which may be stored on a storage device (e.g., storage devices 46, 48, 50, 52; respectively) coupled to the client electronic device (e.g., client electronic devices 36, 38, 40, 42; respectively), may be executed by one or more processors (not shown) and one or more memory architectures (not shown) incorporated into the client electronic device. The storage device (e.g., storage devices 46, 48, 50, 52) may include, but is not limited to: hard disk drives; tape drives; optical drives; solid state drives (SSD); RAID arrays; random access memories (RAM); read-only memories (ROM), compact flash (CF) storage devices, secure digital (SD) storage devices, and memory stick storage devices.

Examples of client electronic device 36, 38, 40, 42 may include, but are not limited to, personal computer 36, laptop computer 38, personal digital assistant 40, a data-enabled, cellular telephone 42, and a dedicated network device (not shown), for example. Using client application 28, 30, 32, 34, users 20, 22, 24, 26 may access compliance evaluation application 10 to conduct an evaluation of the compliance status of an entity relative to a defined standard.

As mentioned above, the devices (e.g., client electronic device 36, 38, 40, 42) accessing compliance evaluation application 10 may be directly coupled to network 14 (or secondary network 18). For example, personal computer 36 is shown directly coupled to network 14 via a hardwired network connection. As such, personal computer 36 (which may execute client application 28) may allow user 20 to access and utilize compliance evaluation application 10 via network 14 (or secondary network 18).

Alternatively, the various client electronic devices accessing compliance evaluation application 10 may be indirectly coupled to network 14 (or secondary network 18). For example, laptop computer 38 is shown wirelessly coupled to network 14 via a wireless communication channel 54 established between laptop computer 38 and wireless access point (i.e., WAP) 56, which is shown directly coupled to network 14. WAP 56 may be, for example, an IEEE 802.11a, 802.11b, 802.11g, 802.11n, Wi-Fi, and/or Bluetooth device that is capable of establishing communication channel 54 between laptop computer 38 and WAP 56.

As is known in the art, the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Additionally, personal digital assistant 40 is shown wirelessly coupled to network 14 via wireless communication channel 58 established between personal digital assistant 40 and cellular/network bridge 60 (which is shown directly coupled to network 14); and cellular telephone 42 is shown wirelessly coupled to network 18 via wireless communication channel 62 between cellular telephone 42 and cellular/network bridge 64 (which is shown directly coupled to network 18).

Client electronic devices 36, 38, 40, 42 may each execute an operating system. Exemplary operating systems may include, but are not limited to, Microsoft Windows XP™, Microsoft Windows CE™, Redhat Linux™, or Apple Mac OS X™.

### Compliance Evaluation Application:

As discussed above, examples of client electronic devices may include, but are not limited to, personal computer 36, laptop computer 38, personal digital assistant 40, a data-enabled, cellular telephone 42, and a dedicated network device (not shown). Accordingly, while personal computer 36 is discussed below, it is to be understood that any client electronic device (including, but not limited to, laptop computer 38, personal digital assistant 40, a data-enabled, cellular telephone 42, and a dedicated network device (not shown)) may be equally utilized.

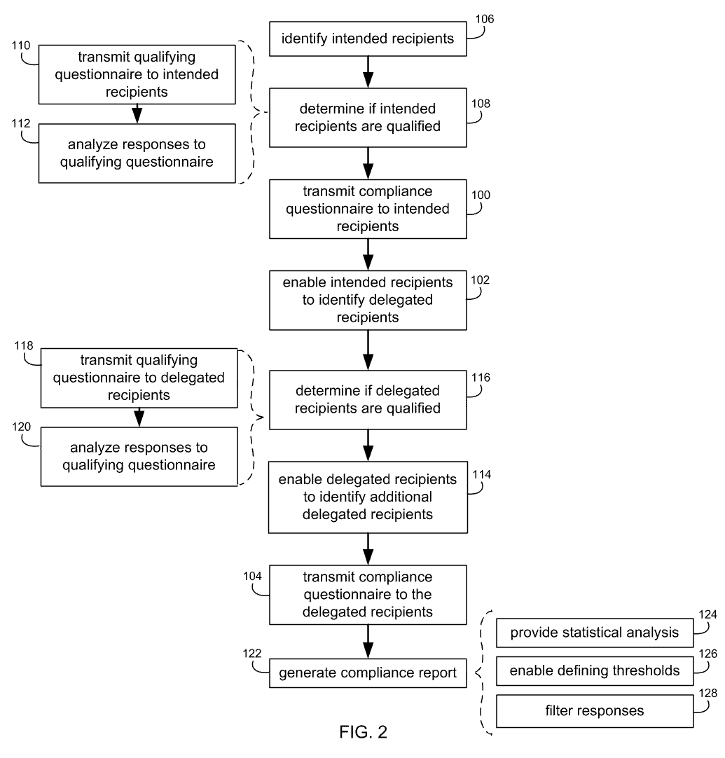

Referring also to FIG. 2, compliance evaluation application 10 may transmit 100 a compliance questionnaire to one or more intended recipients. As will be discussed in greater detail below, compliance evaluation application 10 may also enable 102 the one or more intended recipients to identify one or more delegated recipients of the compliance questionnaire. Furthermore, compliance evaluation application 10 may transmit 104 the compliance questionnaire to the one or more delegated recipients.

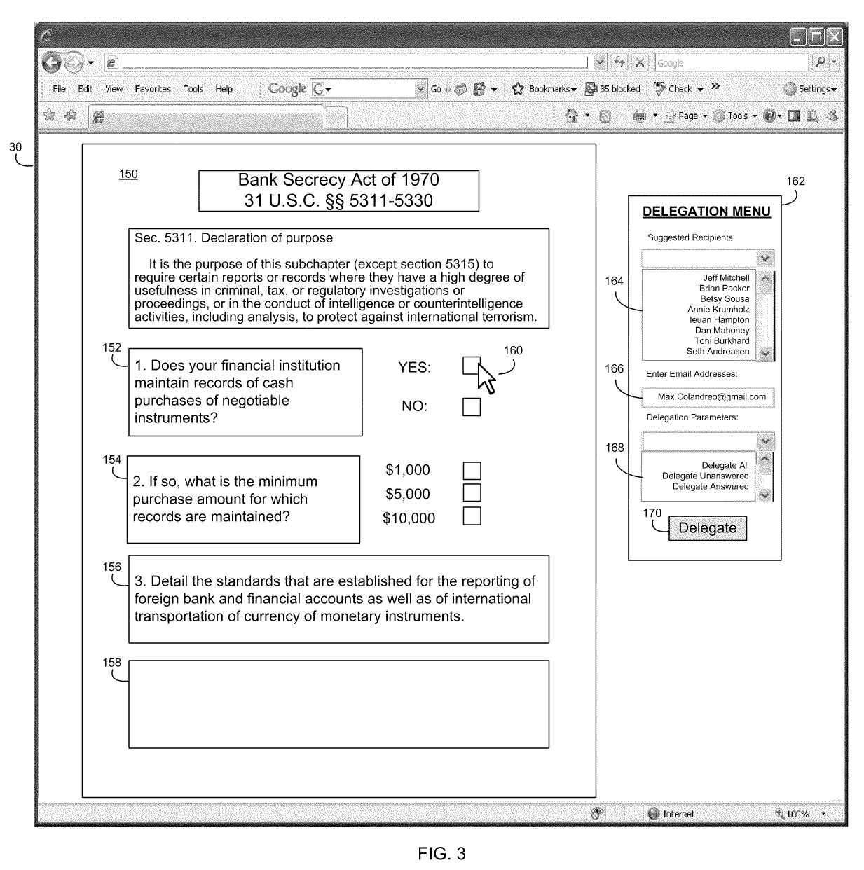

For example, and referring also to FIG. 3, compliance evaluation application 10 may transmit 100 a compliance questionnaire (e.g., compliance questionnaire 150) to one or more intended recipients (e.g., user 22). Compliance questionnaire 150 may be rendered by client application 30, alone or in conjunction with compliance evaluation application 10. Compliance questionnaire 150 may be generated based, at least in part, upon a compliance standard. The compliance standard may include, for example, adopted standards, entity standards, and governance models. As such, the compliance standard may be based upon, at least in part, legislative requirements, administrative regulations, industry standards/guidelines, general business practices, or other applicable standards. Compliance questionnaire 150 may, for example, be used to conduct a compliance evaluation to ascertain the compliance status of an entity (e.g., a business/company, a firm, or an individual) relative to a defined (e.g., compliance) standard.

Exemplary adopted standards may include, but are not limited to: the Bank Secrecy Act/Anti-Money Laundering (BSA/AML); the Health Insurance Portability and Accountability Act (HIPAA); the Federal Financial Institutions Examination Council (FFIEC); the Gramm Leech Bliley Act (GLBA); the National Institute for Standards and Technology (NIST) Special Publication 800-53 Revision 1 and 800-53A; and Federal Information Security Management Act (FISMA). Exemplary entity standards may include, but are not limited to: Local/Corporate Policy & Procedure. Additionally, exemplary governance models may include, but are not limited to: the International Organization for Standardization (ISO); NIST; Information Technology Infrastructure Library (ITIL) Version 3; and Control Objectives for Information and related Technology (CobiT).

Further, entity standards may be defined by the user (e.g., users 20, 22, 24, 26) and/or entity, and may be need-specific. For example, a user (e.g., users 20, 22, 24, 26, an administrator (not shown) or the like) and/or entity may create and input questions to compliance evaluation application 10, and in response, compliance evaluation application 10 may provide a predefined template (not shown) that may be tailored to address the questions of the user and/or entity. Compliance questionnaire 150 may be based upon, at least in part, such entity standards.

For example, a questionnaire initiator (e.g., user 20) may desire to evaluate, e.g., a banking institution's compliance with, e.g., the Bank Secrecy Act (“BSA”). As such, the questionnaire initiator (e.g., user 20) may create and input (e.g., via an appropriate interface, not shown) questions related to the BSA into compliance evaluation application 10. Specifically, user 20 may desire to evaluate whether a banking institution files reports of cash transactions exceeding ten-thousand dollars ($10,000), as required by the BSA. User 20 may utilize personal computer 36, on which client application 28 may be executed, to access compliance evaluation application 10 via network 14. User 20 may then create and input one or more questions related to the BSA requirement, and in response, compliance evaluation application 10 may provide a predefined template (not shown) that may be used for generating compliance questionnaire 150.

While compliance evaluation application 10 may provide a predefined template in response to the questions input by the questionnaire initiator, this is not to be construed as a limitation of this disclosure. Alternatively, compliance evaluation application 10 may provide a predefined template without receiving one or more questions from the user (e.g., users 20, 22, 24, 26), or compliance evaluation application 10 may generate compliance questionnaire 150 without the use of a predefined template.

Continuing with the above-stated example, upon generation of compliance questionnaire 150, compliance evaluation application 10 may enable 106 the questionnaire initiator (e.g., user 20) to identify one or more intended recipients (e.g., user 22) of compliance questionnaire 150. Compliance evaluation application 10 may transmit 100 compliance questionnaire 150 to one or more intended recipients (e.g., user 22), e.g., which may be identified by the questionnaire initiator (e.g., user 20). Additionally/alternatively, compliance evaluation application 10 may transmit 100 compliance questionnaire 150 to one or more intended recipients who may have been previously identified and/or maintained as suggested recipients e.g., in a database (not shown) stored on e.g., storage device 16.

Compliance evaluation application 10 may transmit 100 compliance questionnaire 150 via any number of means known by one of skill in the art. Such means may include, but are not limited to: Hypertext Transfer Protocol (HTTP) and/or Hypertext Transfer Protocol Secure (HTTPS) (via a web browser, as discussed above); File Transfer Protocol (FTP); electronic mail; and postal mail. For example, compliance evaluation application 10 may notify user 22 (e.g., an intended recipient) via electronic mail that user 22 has been identified as an intended recipient of compliance questionnaire 150, e.g., which may be accessed via compliance evaluation application 10.

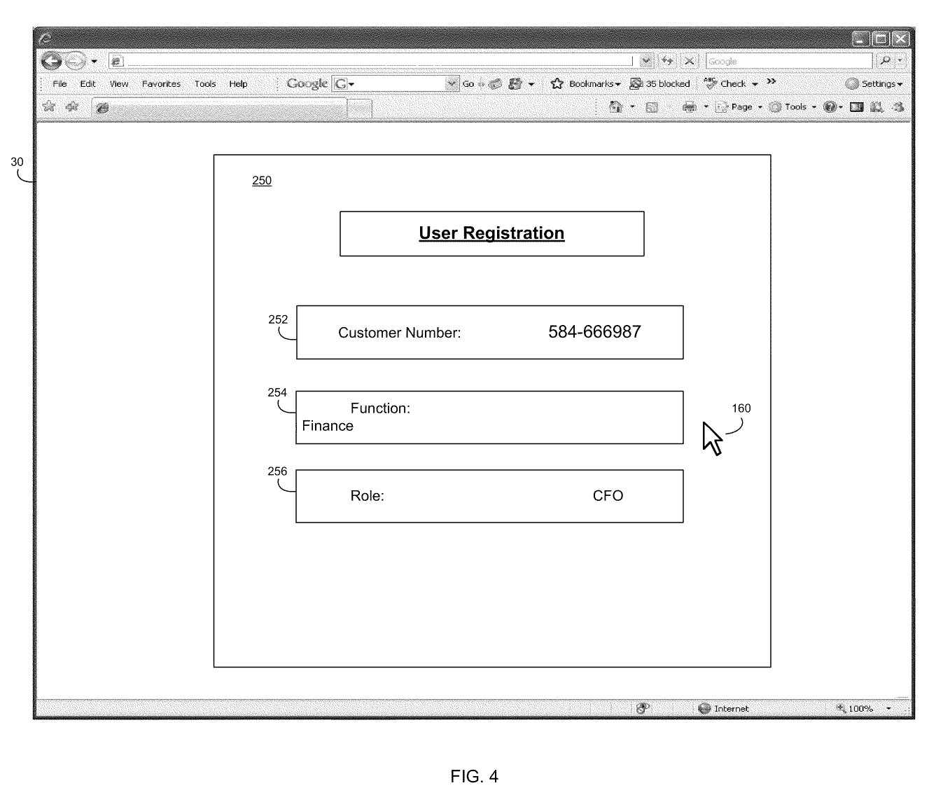

Referring also to FIG. 4, and continuing with the above-stated example, upon receipt of the electronic mail notification, user 22 may, e.g., click a link embedded in the electronic mail (not shown) that may execute client application 30 (e.g., a web browser) to generate user registration page 250, which may request (alone or in conjunction with compliance evaluation application 10) that, e.g., user 22 provide a response to a set of registration requirements. Such registration requirements may include, but are not limited to: customer number 252 (which, e.g., may be associated with a company by compliance evaluation application 10), function 254 (e.g., corporate marketing, corporate legal, marketing, finance, etc.), and role 256 (e.g., CFO, Auditor, Controller, Accountant, etc.). Additionally, compliance evaluation application 10 may enable a user to register multiple customer numbers 252, functions 254, and/or roles 256. For example, a user whose role 256 was an Accounts Payable Clerk may have been promoted to a Junior Accountant. During the process of promotion, that user may be temporarily registered with two roles 256 (i.e., Accounts Payable Clerk and Junior Accountant).

Based, at least in part, upon the user's (e.g., user 22) responses to the registration requirements, compliance evaluation application 10 may transmit 100 all of the questions, or a subset of the questions, from compliance questionnaire 150 to user 22. For example, compliance questionnaire 150 may include one or more compliance questions 152, 154, 156. One of skill in the art will appreciate that the number and nature of compliance questions 152, 154, 156 may vary based upon, at least in part, the relevant compliance standard. As described in the instant example, compliance evaluation application 10 may analyze user 22's customer number 252 (i.e., 584-666987), function 254 (i.e., Finance), and role 256 (i.e., CFO) to determine that user 22 is qualified to answer all of the compliance questions (e.g., compliance questions 152, 154, 156) from compliance questionnaire 150. This is not to be construed as a limitation of this disclosure, however, as one of skill in the art will appreciate that users may not be qualified to answer all questions from a given compliance questionnaire. For example, if user 22's role 256 only indicated, e.g., Junior Accountant, then compliance evaluation application 10 may only transmit 100 compliance questions 152, 154, because user 22 is not likely to be able to detail the standards established for reporting of foreign bank and financial accounts (e.g., compliance question 156).

Upon receipt of, e.g., compliance questionnaire 150, and via client application 30, user 22 may respond to one or more compliance questions (e.g., compliance questions 152, 154, 156) included within compliance questionnaire 150. User 22 may respond to compliance questions 152, 154 utilizing on-screen pointer 160 (e.g., which may be controlled by a pointing device such as a mouse; not shown), e.g., to check an appropriate answer box. Similarly, user 22 may respond to e.g., compliance question 156 by entering (e.g., via a keyboard associated with personal computer 36) a text-based response in compliance response box 158. The type of exemplary compliance questions provided herein are not to be construed as a limitation of this disclosure, as many variations may be employed. For example, the types of compliance questions employed may include, but are not limited to: Leikert scales; multiple choice; true/false; absolute rank; check all that apply; numeric allocation; dropdown boxes; list boxes; single-line text response; multi-line text response; essay; and fill in the blank.

As mentioned above, though illustrated with a separate example, the one or more intended recipients (e.g., user 22) may not be able to answer one or more compliance questions (e.g., one or more of compliance questions 152, 154, 156) included in the compliance questionnaire (e.g., compliance questionnaire 150). In such a situation, compliance evaluation application 10 may enable 102 the one or more intended recipients to identify one or more delegated recipients of the compliance questionnaire. For example, user 22 may not be qualified to answer any of the compliance questions (e.g., compliance questions 152, 154, 156). Compliance evaluation application 10 may thus enable 102 user 22 to identify one or more delegated recipients (e.g., user 24) to answer the compliance questions via delegation menu 162.

Continuing with the above-stated example, in which user 22 may access compliance questionnaire 150 via client application 30, if user 22 wishes to delegate compliance questionnaire 150 to another user, compliance evaluation application 10 may enable 102 user 22 to identify one or more delegated recipients via delegation menu 162. For example, user 22 may click on (via onscreen pointer 160) suggested recipients drop-down menu 164. Clicking on suggested recipients drop-down menu 164 may result in compliance evaluation application 10 enabling 102 user 22 to identify one or more delegated recipients from the list of suggested recipients. The list of suggested recipients may, as discussed above, be stored in a database (not shown) on, e.g., storage device 16, accessible by compliance evaluation application 10. Additionally/alternatively, compliance evaluation application 10 may enable 102 user 22 to identify one or more delegated recipients by inputting one or more email addresses in email entry box 166 of delegation menu 162.

Further, enabling 102 the one or more intended recipients to identify one or more delegated recipients may include enabling the one or more intended recipients to select one or more delegation parameters. For example, compliance evaluation application 10 may provide delegation parameters drop-down menu 168 to enable 102 e.g., user 22 to identify one or more delegated recipients (e.g., user 24) to receive the entire compliance questionnaire 150, to receive one or more unanswered compliance questions (e.g., compliance questions 152, 154, 156), or to receive the answered compliance questions (e.g., to allow the one or more delegated recipients to review compliance questionnaire). Additional/alternative delegation options may also be included depending upon user need and design criteria.

Once user 22 (e.g., the intended recipient) has made desired delegated recipient selections from delegation menu 162, user 22 may then select, via onscreen pointer 160, e.g., delegate button 170. Selecting delegate button 170 may result in compliance evaluation application 10 transmitting 104 the selected compliance questions (e.g., compliance questions 152, 154, 156) of compliance questionnaire 150 to the one or more delegated recipients.

Continuing with the above-stated example, compliance evaluation application 10 may transmit 104 compliance questionnaire 150 to the one or more delegated recipients (e.g., user 24) using the means described above. Again, and as will be discussed in greater detail below, the transmitted 104 compliance questionnaire 150 may be transmitted 104 in whole, or in part, based on the user's (e.g., user 22) selections in e.g., delegation parameters drop-down menu 168 of delegation menu 162.

In a similar manner, and as described above regarding the one or more intended recipients (e.g., user 22), the one or more delegated recipients (e.g., user 24), upon receipt of compliance questionnaire 150, may input responses to compliance questionnaire 150 and provide the responses to compliance evaluation application 10 (using the above-described means). Additionally/alternatively, compliance evaluation application 10 may enable 114 the one or more delegated recipients (e.g., user 24) to identify one or more additional delegated recipients (e.g., user 26).

For example, user 24 may know that the entity (e.g., a banking institution in the illustrated example) maintains records of cash purchases of negotiable instruments (i.e., compliance question 152), but may not know the minimum purchase amount for which records are maintained (i.e., compliance question 154), nor the standards that are established for the reporting of foreign bank and financial accounts as well as of international transportation of currency of monetary instruments (i.e., compliance question 156). As such, compliance evaluation application 10 may enable user 24 to answer compliance question 152, and may enable 114 user 24 to identify one or more additional delegated recipients (e.g., user 26) to respond to compliance questions 154, 156 (generally in the above-described manner). Compliance evaluation application 10 may then transmit the unanswered compliance questions (e.g., compliance questions 154, 156) to the one or more additional delegated recipients, and may provide those recipients with the same delegation options (e.g., allowing further delegation of at least a portion of compliance questionnaire 150).

In light of the above-described examples, it will be understood by one of skill in the art that any set or subset of compliance questions (e.g., compliance questions 152, 154, 156) may be transmitted 100/104 to intended recipients and/or delegated recipients, which may then be further transmitted 104 to additional delegated recipients. Similarly, any number of compliance questionnaires (e.g., compliance questionnaire 150) may be transmitted 100/104 to intended recipients and/or delegated recipients, which may then be further transmitted 104 to additional delegated recipients. This process for distribution of compliance questionnaires and/or compliance questions may be referred to as “viral propagation” by one of skill in the art.

The exemplary method described above is not to be construed as a limitation of this disclosure, as one of skill in the art will understand that many other embodiments are within the scope of this disclosure. For example, and referring to the example regarding the one or more delegated recipients (see above), compliance evaluation application 10 may determine 108 if the one or more intended recipients (e.g., user 22) is qualified to answer one or more compliance questions (e.g., compliance question 152), but not all of the compliance questions (e.g., compliance questions 154, 156). Conversely, compliance evaluation application 10 may determine 116 that the one or more delegated recipients (e.g., user 24) may not be qualified to answer any of the compliance questions (e.g., compliance questions 152, 154, 156), and may enable 114, e.g., user 24 to identify one or more additional delegated recipients (e.g., user 26) to respond to the compliance questionnaire (e.g., compliance questionnaire 150).

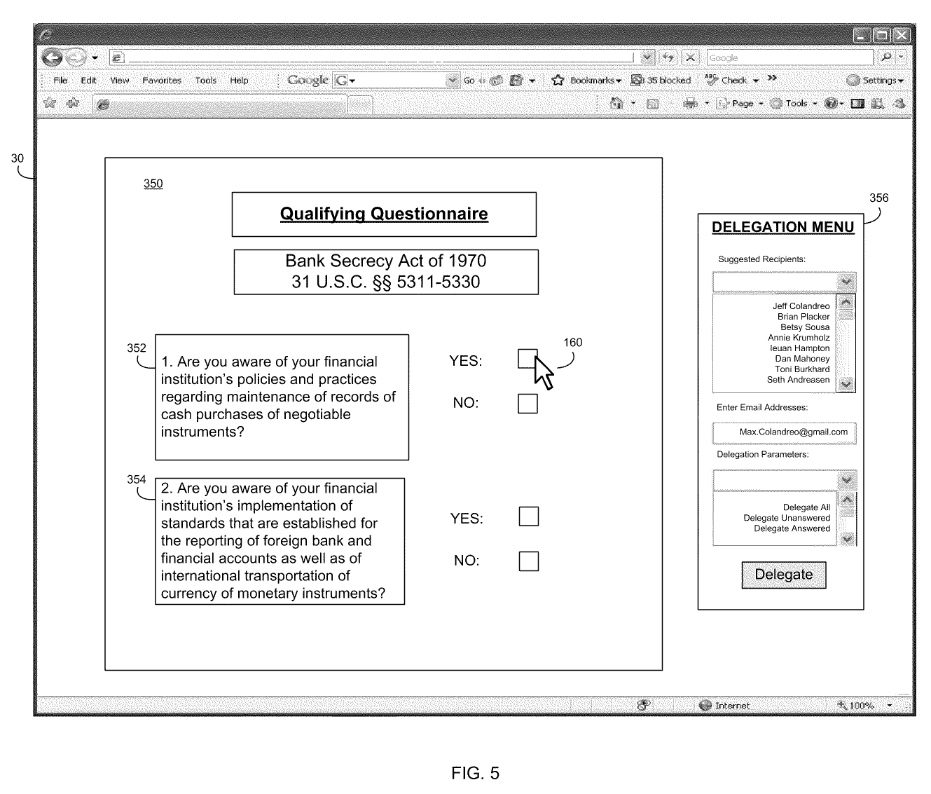

In addition to (or as an alternative to) the user registration process (e.g., user registration 250) described above, compliance evaluation application 10 may determine 108 if the one or more intended recipients (e.g., user 22) is qualified to answer the compliance questionnaire (e.g., compliance questionnaire 150), e.g., prior to transmission 100 of compliance questionnaire to user 22. For example, and referring also to FIG. 5, in determining 108 if user 22 is qualified to answer the compliance questionnaire, compliance evaluation application 10 may transmit 110 qualifying questionnaire 350 to the one or more intended recipients (e.g., user 22). Transmitting 110 qualifying questionnaire 350 may be performed using any number of methods known to one of skill in the art (as described above). As shown, qualifying questionnaire 350 may include one or more qualifying questions 352, 354, e.g., which compliance evaluation application 10 may use, at least in part, to determine 108 if user 22 is qualified to answer the compliance questionnaire (e.g., compliance questionnaire 150).

Upon receipt of qualifying questionnaire 350 (e.g., which may be received in a similar manner as compliance questionnaire 150, described above), the one or more intended recipients (e.g., user 22) may respond to the qualifying questions (e.g., qualifying questions 352, 354) by selecting one or more appropriate responses using, e.g., on-screen pointer 160. The type of exemplary qualifying questions provided herein are not to be construed as a limitation of this disclosure, as many variations may be employed. For example, types of qualifying questions employed may include, but are not limited to: Leikert scales; multiple choice; true/false; absolute rank; check all that apply; numeric allocation; dropdown boxes; list boxes; single-line text response; multi-line text response; essay; and fill in the blank.

Additionally, and similar to delegation menu 162 of compliance questionnaire 150, compliance evaluation application 10 may provide delegation menu 356 in conjunction with qualifying questionnaire 350. Compliance evaluation application 10, via delegation menu 356, may enable the one or more intended recipients (e.g., user 22) to delegate all, or a subset of, the compliance questions included within compliance questionnaire 150 that e.g., user 22 may not be qualified to answer.

Compliance evaluation application 10 may analyze 112 at least one response provided by the one or more intended recipients (e.g., user 22) in response to the qualifying questionnaire (e.g., qualifying questionnaire 350) to determine 108 if the one or more intended recipients may be qualified to answer the compliance questionnaire (e.g., compliance questionnaire 150). For example, compliance evaluation application 10 may analyze 112 the one or more responses to qualifying questionnaire 350 to determine if user 22 demonstrates sufficient knowledge of the entity (e.g., in the context of the subject matter of the compliance questionnaire) to likely be able to answer at least a portion of the questions included within the compliance questionnaire.

For example, user 22 may utilize on-screen pointer 160 to indicate an awareness of the financial institution's policies and practices regarding maintenance of records of cash purchases of negotiable instruments (i.e., qualifying question 352). User 22 may further utilize on-screen pointer 160 to indicate a lack of awareness of the financial institution's implementation of standards that are established for the reporting of foreign bank and financial accounts as well as of international transportation of currency of monetary instruments (i.e., qualifying question 354).

As such, compliance evaluation application 10 may analyze 112 the response of user 22 to qualifying questions 352, 354 and may determine 108 that user 22 may be qualified to answer e.g., compliance questions 152, 154, but not e.g., compliance question 156. Accordingly, compliance evaluation application 10 may transmit 100 a modified version of compliance questionnaire 150 to user 22, providing compliance questions for which user 22 may be qualified to answer (e.g., compliance questions 152, 154).

In a similar manner, compliance evaluation application 10 may also determine 116 if the one or more delegated recipients (e.g., user 24) is qualified to answer the compliance questionnaire (e.g., compliance questionnaire 150) prior to transmitting 104 the compliance questionnaire to the one or more delegated recipients. This may be in addition to (or as an alternative to) the user registration process (e.g., user registration 250) described above. For example, compliance evaluation application 10 may transmit 118 qualifying questionnaire 350 to the one or more delegated recipients (e.g., user 24) in a similar manner as described above. The one or more delegated recipients (e.g., user 24) may answer the qualifying questions, and as described above with reference to the one or more intended recipients, compliance evaluation application 10 may analyze 120 at least one response provided by the one or more delegated recipients (e.g., user 24) in response to the qualifying questionnaire (e.g., qualifying questionnaire 350) to determine 116 if the one or more delegated recipients may be qualified to answer the compliance questionnaire (e.g., compliance questionnaire 150).

For example, and similar to the functionality provided to the one or more intended recipients, user 24 may utilize on-screen pointer 160 to indicate an awareness of the financial institution's policies and practices regarding maintenance of records of cash purchases of negotiable instruments (i.e., qualifying question 352). User 24 may further utilize on-screen pointer 160 to indicate that he may not be aware of his financial institution's implementation of standards that are established for the reporting of foreign bank and financial accounts as well as of international transportation of currency of monetary instruments (i.e., qualifying question 354).

As such, compliance evaluation application 10 may analyze 120 the response of user 24 to qualifying questions 352, 354 and may determine 116 that user 24 may be qualified to answer at least a portion of the questions of the compliance questionnaire (e.g., compliance questions 152, 154, but not e.g., compliance question 156). Therefore, compliance evaluation application 10 may transmit 104 a modified version of compliance questionnaire 150, to provide the compliance questions for which user 24 may be qualified to answer.

Additionally, and similar to delegation menu 162 of compliance questionnaire 150, compliance evaluation application 10 may provide delegation menu 356 in conjunction with qualifying questionnaire 350. Compliance evaluation application 10, via delegation menu 356, may enable the one or more delegated recipients (e.g., user 24) to delegate all, or a subset of, the compliance questions enumerated within compliance questionnaire 150 that e.g., user 24 may not be qualified to answer.

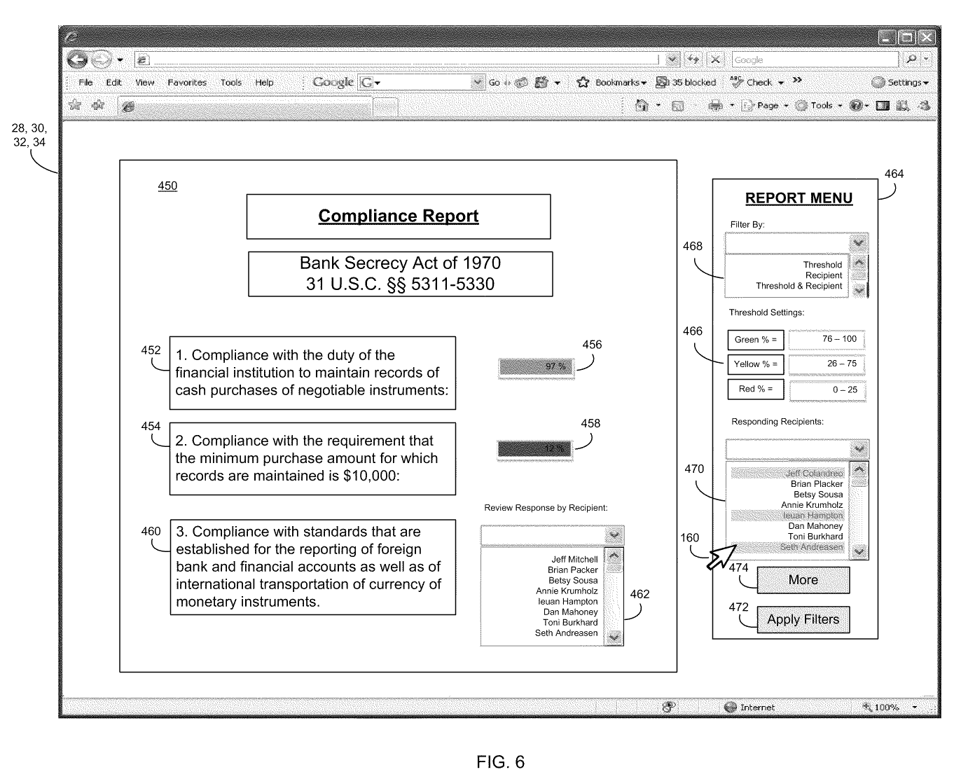

Referring also to FIG. 6, compliance evaluation application 10 may generate 122 a compliance report (e.g., compliance report 450) based, at least in part, upon one or more responses to the compliance questionnaire (e.g., compliance questionnaire 150). Further, the compliance report (e.g., compliance report 450) generated 122 by compliance evaluation application 10 may provide 124 a statistical analysis (e.g., report questions 452, 454 and report answers 456, 458) of the one or more responses to the compliance questionnaire (e.g., compliance questionnaire 150). Generation 122 of compliance report 450 (which may include, but is not limited to, the statistical analysis) may be performed according to “canned”/pre-set guidelines, or the guidelines may be established by the user (e.g., users 20, 22, 24, 26). In the event that the guidelines may be established by the user, compliance evaluation application 10 may enable 126 a questionnaire initiator (e.g., user 20) to define one or more thresholds for the statistical analysis, wherein the one or more thresholds may represent, at least in part, an interpretation of risk by the questionnaire initiator.

Continuing with the above-stated example, the questionnaire initiator (e.g., user 20) may desire to conduct an evaluation of an entity's (e.g., a banking institution) compliance status relative to a defined (e.g., compliance) standard. As such, compliance evaluation application 10 may generate 122 compliance report 450 in response to a request by, e.g., user 20. Compliance evaluation application 10 may generate 122 report questions 452, 454 and report answers 456, 458 by e.g., calculating the average response of the one or more intended recipients (e.g., user 22), the one or more delegated recipients (e.g., user 24), and the one or more additional delegated recipients (e.g., user 26) to compliance questions 152, 154. User 20 may then utilize e.g., client application 28 to view the generated 122 compliance report 450.

Additionally, if a report question (e.g., report question 460) may not be statistically analyzed (e.g., a text-based response), compliance evaluation application 10 may provide e.g., user 20 with recipient drop-down box 462 to enable user 20 to view the responses of individual recipients (e.g., users 22, 24, 26). Further, compliance evaluation application 10 may provide report menu 464 to enable e.g., user 20 to select various threshold and filtering options.

For example, compliance evaluation application 10 may enable 126 the questionnaire initiator (e.g., user 20) to define one or more thresholds (via e.g., threshold settings field 466) for the statistical analysis, wherein the one or more thresholds may represent, at least in part, the interpretation of risk by user 20. Illustratively, if e.g., user 20 interprets an entity's (e.g., a banking institution) risk of non-compliance with e.g., the BSA to be “green” (e.g., representing low risk) when seventy-six percent (76%) or more of the recipients' (e.g., users 22, 24, 26) responses to the compliance questionnaire (e.g., compliance questionnaire 150) conform to the BSA, user 20 may define this threshold in threshold settings field 466. Compliance evaluation application 10 may then indicate this interpretation of risk by displaying the field of the report answer (e.g., report answer 456) in the color green (when the calculated average response of the recipients falls within this threshold).

Conversely, if user 20 interprets an entity's risk of non-compliance with the BSA to be “red” (e.g., representing high risk) when twenty-five percent (25%) or less of the recipients' responses to the compliance questionnaire conform to the BSA, user 20 may define this threshold in threshold settings field 466. Compliance evaluation application 10 may then indicate this by displaying the field of the report answer (e.g., report answer 458) in the color red (when the calculated average response of the recipients falls within this threshold).

The above-stated example illustrated the generation 122 of compliance report 450 by a questionnaire initiator. This is not to be construed as a limitation of this disclosure, though, as one of skill in the art will understand that several variations are within the scope of this disclosure. For example, compliance evaluation application 10 may enable any user/recipient (e.g., users 20, 22, 24, 26) to generate 122 a compliance report (e.g., compliance report 450).

Compliance evaluation application 10 may also filter 128 the one or more responses to the compliance questionnaire (e.g., compliance questionnaire 150) in accordance with filtering criteria defined, at least in part, by one or more of a questionnaire initiator (e.g., user 20), the one or more intended recipients (e.g., user 22), and the one or more delegated recipients (user 24). For example, compliance evaluation application 10 may provide report menu 464 to enable e.g., user 20 to apply filtering options. As such, user 20 may select a filtering method via filter-by drop-down menu 468. If, e.g., user 20 selects the filtering method “Recipient” in filter-by drop-down menu 468, compliance evaluation application 10 may enable user 20 to select one or more recipients via responding recipients drop-down menu 470. When user 20 selects apply filters button 472, compliance evaluation application 10 may filter 128 the one or more responses of the non-selected recipients (e.g., Brian Packer, Betsy Sousa, Annie Krumholz, Dan Mahoney, and Toni Burkhard) and may generate 122 compliance report 450 based upon the one or more responses of the selected recipients (e.g., Jeff Mitchell, Ieuan Hampton, and Seth Andreasen).

Compliance evaluation application 10 may also provide more button 474 to enable e.g., user 20 to select several other filtering and/or reporting options. The other filtering and/or reporting options may include, but are not limited to: “canned”/pre-set reports (e.g., from a previously-established/predefined report template); crosstab tables; suppress selected responses temporarily; create/set answer labels; set values for statistics; include/exclude text values in report; select statistics methods; hide results obtained from less than a given number of respondents; time series support; and significance reporting.

A number of implementations have been described. Nevertheless, it will be understood that various modifications may be made. Accordingly, other implementations are within the scope of the following claims.

What is claimed is:

1. A method comprising:
transmitting a compliance questionnaire to one or more intended recipients;
enabling the one or more intended recipients to identify one or more delegated recipients of the compliance questionnaire; and
transmitting the compliance questionnaire to the one or more delegated recipients.

2. The method of claim 1 further comprising:
determining if the one or more intended recipients is qualified to answer the compliance questionnaire.

3. The method of claim 2 wherein determining if the one or more intended recipients is qualified to answer the compliance questionnaire includes:
transmitting a qualifying questionnaire to the one or more intended recipients; and
analyzing at least one response provided by the one or more intended recipients in response to the qualifying questionnaire to determine if the one or more intended recipients is qualified to answer the compliance questionnaire.

4. The method of claim 1 further comprising:
determining if the one or more delegated recipients is qualified to answer the compliance questionnaire.

5. The method of claim 4 wherein determining if the one or more delegated recipients is qualified to answer the compliance questionnaire includes:
transmitting a qualifying questionnaire to the one or more delegated recipients; and
analyzing at least one response provided by the one or more delegated recipients in response to the qualifying questionnaire to determine if the one or more delegated recipients is qualified to answer the compliance questionnaire.

6. The method of claim 1 further comprising:
generating the compliance questionnaire based, at least in part, upon a compliance standard, wherein the compliance standard is selected from the group consisting of: adopted standards, entity standards, and governance models.

7. The method of claim 1 further comprising:
generating a compliance report based, at least in part, upon one or more responses to the compliance questionnaire.

8. The method of claim 7 wherein generating the compliance report includes:
filtering the one or more responses to the compliance questionnaire in accordance with filtering criteria defined, at least in part, by one or more of a questionnaire initiator, the one or more intended recipients, and the one or more delegated recipients.

9. The method of claim 7 wherein generating the compliance report includes:
providing a statistical analysis of the one or more responses to the compliance questionnaire.

10. The method of claim 9 wherein providing the statistical analysis includes:
enabling a questionnaire initiator to define one or more thresholds for the statistical analysis, wherein the one or more thresholds represent, at least in part, an interpretation of risk by the questionnaire initiator.

11. A computer program product residing on a computer readable medium having a plurality of instructions stored thereon which, when executed by a processor, cause the processor to perform operations comprising:
transmitting a compliance questionnaire to one or more intended recipients;
enabling the one or more intended recipients to identify one or more delegated recipients of the compliance questionnaire; and
transmitting the compliance questionnaire to the one or more delegated recipients.

12. The computer program product of claim 11 further comprising instructions for:
determining if the one or more intended recipients is qualified to answer the compliance questionnaire.

13. The computer program product of claim 12 wherein the instructions for determining if the one or more intended recipients is qualified to answer the compliance questionnaire include:
transmitting a qualifying questionnaire to the one or more intended recipients; and
analyzing at least one response provided by the one or more intended recipients in response to the qualifying questionnaire to determine if the one or more intended recipients is qualified to answer the compliance questionnaire.

14. The computer program product of claim 11 further comprising instructions for:
determining if the one or more delegated recipients is qualified to answer the compliance questionnaire.

15. The computer program product of claim 14 wherein the instructions for determining if the one or more delegated recipients is qualified to answer the compliance questionnaire include:
transmitting a qualifying questionnaire to the one or more delegated recipients; and
analyzing at least one response provided by the one or more delegated recipients in response to the qualifying questionnaire to determine if the one or more delegated recipients is qualified to answer the compliance questionnaire.

16. The computer program product of claim 11 further comprising instructions for:
generating the compliance questionnaire based, at least in part, upon a compliance standard, wherein the compliance standard is selected from the group consisting of: adopted standards, entity standards, and governance models.

17. The computer program product of claim 11 further comprising instructions for:
generating a compliance report based, at least in part, upon one or more responses to the compliance questionnaire.

18. The computer program product of claim 17 wherein the instructions for generating the compliance report include:
filtering the one or more responses to the compliance questionnaire in accordance with filtering criteria defined, at least in part, by one or more of a questionnaire initiator, the one or more intended recipients, and the one or more delegated recipients.

19. The computer program product of claim 17 wherein the instructions for generating the compliance report include:
providing a statistical analysis of the one or more responses to the compliance questionnaire.

20. The computer program product of claim 19 wherein the instructions for providing the statistical analysis include:
enabling a questionnaire initiator to define one or more thresholds for the statistical analysis, wherein the one or more thresholds represent, at least in part, an interpretation of risk by the questionnaire initiator.
